(19) United States
(12) Patent Application Publication
(10) Pub. No.: US 2004/0148494 A1
(43) Pub. Date: Jul. 29, 2004

(54) Method and apparatus for reducing register usage within a pipelined processor

(76) Inventor: Jan Civlin, Sunnyvale, CA (US)

Correspondence Address: PARK, VAUGHAN & FLEMING LLP, 508 SECOND STREET, SUITE 201, DAVIS, CA, 95616, US

(21) Appl. No.: 10/354,332

(22) Filed: Jan. 29, 2003

(51) Int. Cl. G06F 9/30

(52) U.S. Cl. 712/218

(57) ABSTRACT

One embodiment of the present invention provides a system that facilitates eliminating register usage for temporary operands involved in pipeline bypassing operations. During operation, the system receives a series of instructions at a processor, wherein the processor recognizes that the series of instructions can make use of a pipeline bypassing mechanism. During the pipeline bypassing operation, the processor examines an indicator associated with the series of instructions. If the indicator is set, the processor does not store the temporary operand used by the series of instructions into the register file of the processor, because the temporary operand will not be used by subsequent instructions.

### BACKGROUND

1. Field of the Invention

The present invention relates to the design of computer systems. More specifically, the present invention relates to a method and an apparatus for reducing register usage within a pipelined processor.

2. Related Art

As microprocessor clock speeds continue to increase at an exponential rate, processor designers are increasingly relying on a technique known as “pipelining” to provide faster instruction execution. Pipelines include a number of stages that perform the various operations required to execute computer instructions.

For example, a pipeline can include separate stages for, instruction fetching, instruction decoding, operand retrieval, instruction execution, and operand writeback. Intermediate pipeline results are stored in latches between the pipeline stages, thereby allowing instruction execution to be overlapped between pipeline stages. In the above example, a first instruction can be executing in the operand writeback stage, while a second instruction is executing in the instruction execution stage, a third instruction is executing in the operand retrieval stage, a fourth instruction is executing in the instruction decoding stage, and a sixth instruction is executing in the instruction fetch stage.

Pipelined processors typically include a bypassing mechanism that allows results from an instruction to bypass the register file and feed directly back into the pipeline. This can significantly increase execution speed in situations where data dependencies cause an instruction to wait for a result of a preceding instruction. For example, consider the following sequence of program instructions.

ld r3<-[mem1]

inc r3

st r3->[mem2]

In this example, the processor loads register r3 from memory location 1, increments the value in r3, and then stores the value from r3 into memory location 2. If the processor has a bypassing mechanism, the processor can send the value retrieved from memory location 1 directly to the adder to increment the value, without having to wait for the value to first be stored in r3. Furthermore, after the value is incremented, the incremented value can be stored to memory location 2, without having to wait for the incremented value to be stored back into r3.

In many circumstances, the value stored in r3 is a temporary operand that is not used by subsequent instructions. Hence storing this temporary operation in r3 needlessly increases the number of registers that are used by the program. This means that fewer registers are available to store other operands. Note that, the processor cannot determine that the temporary operand stored in r3 will not be used by subsequent instruction, so the processor must save the temporary operand in r3 in spite of the fact that it is not necessary to do so.

Hence, what is needed is a method and an apparatus for reducing unnecessary register usage within a pipelined processor without the above-listed problems.

### SUMMARY

One embodiment of the present invention provides a system that facilitates eliminating register usage for temporary operands involved in pipeline bypassing operations. During operation, the system receives a series of instructions at a processor, wherein the processor recognizes that the series of instructions can make use of a pipeline bypassing mechanism. During the pipeline bypassing operation, the processor examines an indicator associated with the series of instructions. If the indicator is set, the processor does not store the temporary operand used by the series of instructions into the register file of the processor, because the temporary operand will not be used by subsequent instructions.

In a variation of this embodiment, the system generates the series of instructions within a compiler and in doing so determines if a temporary operand used by the series of instructions needs to be saved within the register file. If so, the compiler sets the indicator associated with the series of instructions to indicate that the temporary operand does not need to be saved.

In a further variation, determining if the temporary operand needs to be saved involves determining if the temporary operand is likely to be used by subsequent instructions.

In a further variation, the indicator is encoded in one or more bits within an instruction in the series of instructions.

In a further variation, performing the bypassing operation within the processor involves determining if a named register used by the series of instructions is a scratch register that holds a value that will not be accessed again by subsequent instructions, and which is subject to a pipeline bypassing operation. If so, the system does not write the value of the named register to the register file.

### BRIEF DESCRIPTION OF THE FIGURES

FIG. 1 illustrates a compiler in accordance with an embodiment of the present invention.

FIG. 2 illustrates a processor and memory in accordance with an embodiment of the present invention.

FIG. 3 illustrates an instruction pipeline in accordance with an embodiment of the present invention.

FIG. 4 presents a flowchart illustrating the process of compiling a program in accordance with an embodiment of the present invention.

FIG. 5 presents a flowchart illustrating the process of executing a series of instructions in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Compiler

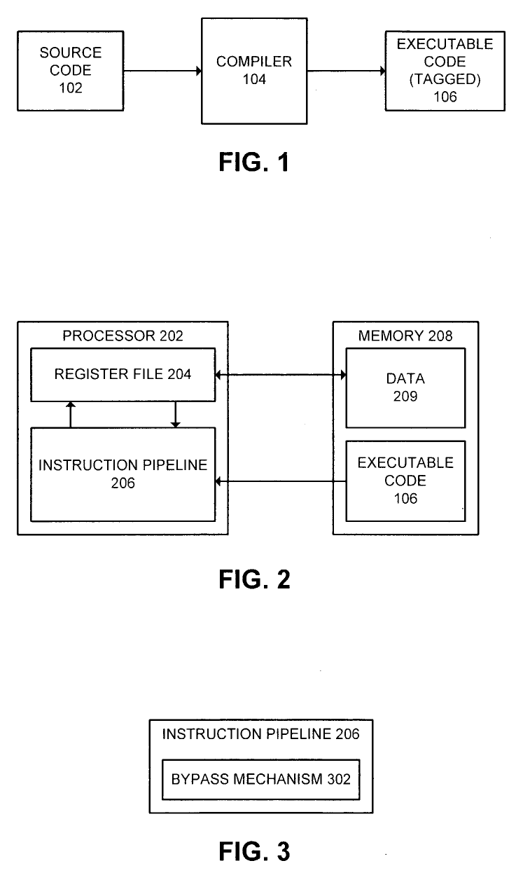

FIG. 1 illustrates a compiler in accordance with an embodiment of the present invention. Compiler 104 receives source code 102, which is to be compiled into executable code 106 for a target processor. Compiler 104 processes this source code and generates executable code 106. In doing so, compiler 104 examines this executable code to identify sections of code that can use the bypassing mechanism of the processor. Upon identifying a section of code that can use the bypassing mechanism, and that uses a temporary operand that will not be used in subsequent instructions, the compiler tags the series of instructions with an indicator to inform the processor to not save the temporary operand in the register file. Finally, the compiler saves the tagged series of instructions as executable code 106.

Processor System

FIG. 2 illustrates a processor 202 and a memory 208 in accordance with an embodiment of the present invention. Processor 202 can generally include any type of processor, including, but not limited to, a microprocessor, a mainframe computer, a digital signal processor, a personal organizer, a device controller, and a computational engine within an appliance. Processor 202 includes instruction pipeline 206 and register file 204. Memory 208 includes tagged executable code 106.

During operation, instruction pipeline 206 receives instructions from executable code 106 and data from register file 204. Register file 204 is used to store operands that are manipulated by instruction pipeline 206. Note that data items retrieved from data area 209 in memory 208 are typically first loaded into register file 204 before being processed by instruction pipeline 206. Similarly, results produced by instruction pipeline 206 are typically first stored in register file 204 before being stored to data area 209 in memory 208. However, data items retrieved from memory 208 can sometimes be bypassed directly into instruction pipeline 206 without first being stored in register file 204. Similarly, results produced by instruction pipeline 206 can sometimes by bypassed directly to memory 208 without first being stored in register file 204.

Depending on the state of an indicator encoded within executable code 106, a bypass mechanism associated with instruction pipeline 206 can elect not to save a given temporary operand in register file 204, thereby preventing an unnecessary use of a register, and thereby reducing register pressure in register file 204.

Instruction Pipeline

FIG. 3 illustrates an instruction pipeline 206 in accordance with an embodiment of the present invention. Instruction pipeline 206 includes a bypass mechanism 302. Bypass mechanism 302 bypasses storing an intermediate operand in register file 204 when, for example, the following instruction pattern is recognized.

Id r3<-[mem1]

inc r3

st r3->[mem2]

In this example, the processor loads a value into register r3 from memory location 1, increments the value in r3, and then stores the value in r3 into memory location 2. Note that the present invention can generally be applied to any bypassing operation involving a temporary operand, which is not used by subsequent instructions and is not limited to the illustrated bypassing operation.

Bypass mechanism 302 can determine that the value retrieved from memory location 1 can be sent directly to the adder to increment the value, without having to wait for the value to be stored in r3. Furthermore, after the value is incremented, the incremented value can be stored to memory location 2, without having to wait for the incremented value to be stored back into r3.

Process of Compiling a Program

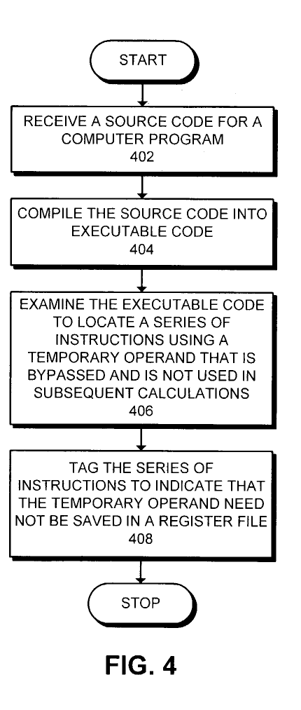

FIG. 4 presents a flowchart illustrating the process of compiling a program in accordance with an embodiment of the present invention. The system starts when a source code for a computer program is received (step 402). Next, the system compiles the source code into executable code (step 404).

After the source code has been compiled into executable code, the system examines the executable code to identify a series of instructions that makes use of a temporary operand that is not used by subsequent instructions (step 406). Next, the system tags the series of instructions to indicate that the temporary operand does not need to be saved in register file 204 (step 408).

Process of Executing Instructions

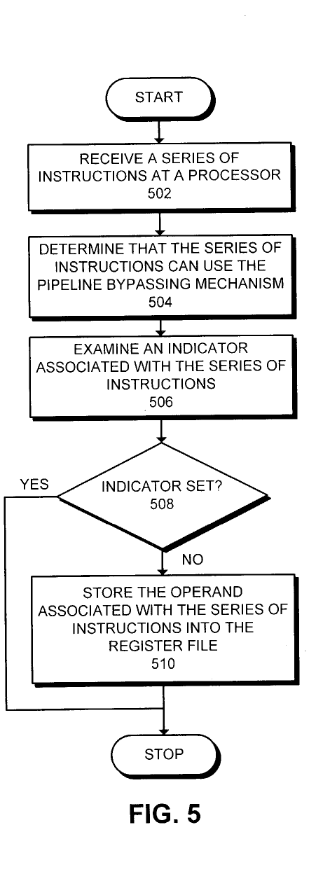

FIG. 5 presents a flowchart illustrating the process of executing a series of instructions in accordance with an embodiment of the present invention. The system starts when a processor receives a series of instructions to be executed (step 502). Next, the system determines that the series of instructions can use the pipeline bypassing mechanism (step 504). The system also examines an indicator associated with the series of instructions, wherein the indicator indicates that a temporary operand used by the series of instructions does not need to be saved in the processor's register file (step 506).

If the indicator is set (step 508), the processor bypasses storing the temporary operand into the register file. Otherwise, the system stores the operand into the register file (step 510).

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for eliminating register usage for temporary operands involved in a pipeline bypassing operation, comprising:
receiving a series of instructions at a processor, wherein the processor recognizes that the series of instructions can make use of a pipeline bypassing mechanism;
examining an indicator associated with the series of instructions; and
if the indicator is set, not storing a temporary operand used by the series of instructions into a register file of the processor;
whereby not storing the temporary operand in the register file relieves pressure on the register file.

2. The method of claim 1, further comprising:
generating the series of instructions within a compiler;
determining if the temporary operand used by the series of instructions needs to be saved within the register file; and
if the temporary operand does not need to be saved, setting the indicator associated with the series of instructions.

3. The method of claim 2, wherein determining if the temporary operand needs to be saved involves determining if the temporary operand is likely to be used by subsequent instructions.

4. The method of claim 1, wherein the indicator is encoded in one or more bits within an instruction in the series of instructions.

5. The method of claim 1, wherein performing the pipeline bypassing operation within the processor involves:
determining if a named register used within the series of instructions is a scratch register that holds a value that will not be accessed again by subsequent instructions, and which is subject to the pipeline bypassing operation, so that the value does not have to be stored in the register file; and
if so, not writing the value of the named register to the register file.

6. An apparatus for eliminating register usage for temporary operands involved in a pipeline bypassing operation, comprising:
a receiving mechanism configured to receive a series of instructions at a processor, wherein the processor recognizes that the series of instructions can make use of a pipeline bypassing mechanism;
an examining mechanism configured to examine an indicator associated with the series of instructions; and
a storing mechanism configured to not store a temporary operand used by the series of instructions into a register file of the processor if the indicator is set;
whereby not storing the temporary operand in the register file relieves pressure on the register file.

7. The apparatus of claim 6, further comprising:
a generating mechanism configured to generate the series of instructions within a compiler;
a determining mechanism configured to determine if the temporary operand used by the series of instructions needs to be saved within the register file; and
a setting mechanism configured to set the indicator associated with the series of instructions if the temporary operand does not need to be saved.

8. The apparatus of claim 7, wherein determining if the temporary operand needs to be saved involves determining if the temporary operand is likely to be used by subsequent instructions.

9. The apparatus of claim 6, wherein the indicator is encoded in one or more bits within an instruction in the series of instructions.

10. The apparatus of claim 6, further comprising:
a determining mechanism configured to determine if a named register used within the series of instructions is a scratch register that holds a value that will not be accessed again by subsequent instructions, and which is subject to the pipeline bypassing operation, so that the value does not have to be stored in the register file; and
a writing mechanism configured to not write the value of the named register to the register file if the named register used within the series of instructions is the scratch register that holds the value that will not be accessed again by subsequent instructions.

11. A means for eliminating register usage for temporary operands involved in a pipeline bypassing operation, comprising:
a receiving means for receiving a series of instructions at a processor, wherein the processor recognizes that the series of instructions can make use of a pipeline bypassing mechanism;
an examining means for examining an indicator associated with the series of instructions; and
a storing means configured to not store a temporary operand used by the series of instructions into a register file of the processor if the indicator is set;
whereby not storing the temporary operand in the register file relieves pressure on the register file.

12. The means of claim 11, further comprising:
a generating means for generating the series of instructions within a compiler;
a determining means for determining if the temporary operand used by the series of instructions needs to be saved within the register file; and
a setting means for setting the indicator associated with the series of instructions if the temporary operand does not need to be saved.

13. The means of claim 12, wherein determining if the temporary operand needs to be saved involves determining if the temporary operand is likely to be used by subsequent instructions.

14. The means of claim 11, wherein the indicator is encoded in one or more bits within an instruction in the series of instructions.

15. The means of claim 11, further comprising:
a determining means for determining if a named register used within the series of instructions is a scratch register that holds a value that will not be accessed again by subsequent instructions, and which is subject to the pipeline bypassing operation, so that the value does not have to be stored in the register file; and
a writing means configured to not write the value of the named register to the register file if the named register used within the series of instructions is the scratch register that holds the value that will not be accessed again by subsequent instructions.

16. A compiler for eliminating register usage for operands involved in a pipeline bypassing operation within a processor, comprising:
receiving a source code for a computer program; and
determining that an operand used by a series of instructions does not need to be stored into a register file of the processor.

17. The compiler of claim 16, further comprising:
generating the series of executable instructions within the compiler;
determining if a temporary operand used by the series of executable instructions needs to be saved within the register file; and
if the temporary operand does not need to be saved, setting an indicator associated with the series of instructions;
whereby not storing the operand in the register file relieves pressure on the register file.

18. The compiler of claim 17, wherein determining if the temporary operand needs to be saved involves determining if the temporary operand is likely to be used by subsequent instructions.

19. The compiler of claim 18, wherein the indicator is encoded in one or more bits within an instruction in the series of instructions.

20. The compiler of claim 16, wherein performing the pipeline bypassing operation within the processor involves:
determining if a named register used within the series of instructions is a scratch register that holds a value that will not be accessed again by subsequent instructions, and that is subject to the pipeline bypassing operation so that the value does not have to be stored in the register file; and
if so, not writing the value for the named register to the register file.
